(19) United States
(12) Patent Application Publication
(10) Pub. No.: US 2007/0286383 A1
(43) Pub. Date: Dec. 13, 2007

(54) Method and apparatus for controlling communications of interest in a specific issue between parties known to each other

(75) Inventor: Kenneth C. Fan, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SamePage, LLC, Brookline, MA (US)

(21) Appl. No.: 11/805,067

(22) Filed: May 21, 2007

Related U.S. Application Data
(60) Provisional application No. 60/808,567, filed on May 26, 2006.

(51) Int. Cl. H04M 3/42

(52) U.S. Cl. 379/201.01

(57) ABSTRACT

A system and method for controlling communications between parties that are known to each other is provided. Communications are received from a first and a second party that are identified to each other, and include the parties respective levels of interest in an issue relating to the parties. If a particular party does not communicate its level of interest within an given timeframe, that party's level of interest may be assumed to be a default level of interest. Representations of the levels of interest are then communicated to the parties as a function of the levels of interest. In some situations, based on a given party's level of interest, a representation of the counterparty's level of interest may not be communicated to the party.

### RELATED APPLICATION

This application claims the benefit of U.S. Provisional Application No. 60/808,567, filed on May 26, 2006. The entire teachings of the above application are incorporated herein by reference.

### BACKGROUND OF THE INVENTION

When one party has a certain interest in a particular issue relating to another party, such as a romantic or business interest, it may be difficult for that party to express its interest to the other party due to concerns of pride, negotiating position, social norms, or tact. This difficulty may arise in situations including, but not limited to, interpersonal relationships and diplomatic or business negotiations. Furthermore, when one party wishes to reveal a negative level of interest to another party, they are often reluctant to do so due to the awkwardness of communicating such a negative level of interest.

### SUMMARY OF THE INVENTION

A system and method is provided that enables parties to communicate their respective interests in an issue in a risk-free and polite manner. A user of the system may communicate his or her interest in a specified issue to another party without having to suffer through awkward conversation. Furthermore, a user of the system may politely communicate his or her negative level of interest in an issue to the other party without causing undue embarrassment or feelings of judgment. By providing each party with an identification of the counterparty and the issue at hand, the system enables the parties to get on the “same page” about their respective interests in the issue.

In one embodiment, a method is provided for controlling communications between parties that are known and identified to each other. According to the method, a first communication is received from a first party. This communication includes a first level of interest in an issue relating to the second party, and a second communication including a second level of interest in the issue is then requested from the second party. A first representation of the first level of interest is then communicated to the second party and a second representation of the second level of interest is communicated to the first party as a function of the first and second levels of interest. It should be understood that “as a function of” covers situations in which the representations of the levels of interest are communicated, and in certain conditions, not communicated.

In one embodiment, the first party may initiate communications and may include an identification of the second party in the first communication. When requesting the second communication from the second party, the second party may be informed of the identity of the first party, the issue, and receipt of the first communication from the first party. In another embodiment, communications between the first and second parties may be initiated through prompting by a third party, such as an automated server.

The representations of the levels of interest may be the actual levels of interest or may be based on the levels of interest. The levels of interest may be binary, ternary, or multi-valued levels of interest. For example, each level of interest may be one of multiple values, and the lowest-valued level of interest of the first and second levels of interest may be communicated to both parties. The levels of interest may be of many different types of interest, including, but not limited to, romantic or non-romantic interpersonal levels of interest, business levels of interest, and diplomatic levels of interest. In one embodiment, the second communication may be assumed to include a negative level (or other default level) of interest in the issue if the second communication is not received from the second party within a given timeframe.

It may be determined that both of the representations be communicated to the parties if both levels of interest are positive, that communication of the first representation may be withheld from the second party if second level of interest is negative, or that communication of the second representation may be withheld from the first party if the first level of interest is negative. Additional communications between the parties, or actions by the parties, may be triggered in the case where both levels of interest are positive.

Furthermore, the first representation may be communicated to the second party if the first level of interest is negative and the second level of interest is positive, and the second representation may be communicated to the first party if the second level of interest is negative and the first level of interest is positive.

Additionally, the first communication may include a comment and may be communicated to the second party. Likewise, the second communication may include a comment and may be communicated to the first party.

Controlling communications may be performed in a variety of environments (e.g., a mobile network, a computer network, or electronic messaging environment) and may be added to a system normally supporting other forms of communications services involving at least a first and a second party. Additionally, payment may be collected from at least one of the parties if both the first and second levels of interest are positive.

In another embodiment, a system controls communications between parties known and identified to each other. The system includes a comparison module that compares first and second levels of interest in respective first and second communications received from respective first and second parties submitting the communications. The system also includes a control module that communicates a first representation of the first level of interest to the second party and a second representation of the second level of interest to the first party as a function of the first and second levels of interest.

In yet another embodiment, a network may control communications between parties known and identified to each other. The network includes a first user interface used by a first party to submit a first communication that includes a first level of interest in an issue relating to a second party, and a second user interface used by a second party to submit a second communication that includes a second level of interest in the issue. The network also includes a server that compares the levels of interest and communicates a first representation of the first level of interest to the second party and a second representation of the second level of interest to the first party as a function of the first and second levels of interest.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a flow diagram illustrating controlling of communications in a romantic environment.

FIG. 2 is a flow diagram illustrating events that take place prior to the controlling of communications.

FIG. 3 is a flow diagram illustrating a first party initiating communications between parties.

FIG. 4 is a flow diagram illustrating requesting a communication from a second party.

FIG. 5 is a flow diagram illustrating determining and communicating messages to parties.

FIG. 6 is a flow diagram illustrating parties receiving and processing messages and taking further action based on the messages.

FIG. 7 is a detailed flow diagram illustrating controlling of communications between two parties.

FIG. 8 is a detailed flow diagram illustrating logic used in the controlling of communications in FIG. 7.

FIG. 9 is a detailed flow diagram illustrating initiating and controlling of communications between two parties.

FIG. 10 is a block diagram illustrating controlling of communications between two parties.

FIG. 11 is a block diagram illustrating binary logic used in the controlling of communications in FIG. 10.

FIG. 12 is a block diagram illustrating ternary logic used in the controlling of communications in FIG. 10.

FIG. 13 is a block diagram illustrating initiating and controlling of communications between two parties.

FIG. 14 is a network diagram illustrating controlling of communications between two parties.

FIG. 15 is a schematic diagram of a trade show type environment in which an embodiment of the present invention is deployed.

### DETAILED DESCRIPTION OF THE INVENTION

A description of example embodiments of the invention follows.

Various methods exist by which a party may express his or her interest in an issue to another party. In one method, a party anonymously sends a message containing his or her interest to another party. Such a method has the disadvantage of not identifying the sending party to the receiving party. This causes uncertainty on the part of the receiving party, and therefore, the sending party may never be certain whether the receiving party received or responded to the message. Another disadvantage of this method is the inability of the parties to explicitly communicate a negative level of interest in an issue to a counterparty having a positive level of interest in the issue.

The problems associated with communicating such levels of interest exist in many types of relationships, such as romantic relationships (e.g., dating), business relationships (e.g., contract negotiations), and diplomatic relationships. Feelings of rejection and awkwardness are particularly acute in the romantic arena, as an individual wishing to express a romantic interest to another often has difficulty communicating his or her level of interest. Such individuals struggle to communicate their levels of interest due to fear of rejection, shyness, and avoidance of awkward situations and communications. Therefore, there is often miscommunication, misleading signs, and missed chances.

The present invention overcomes these deficiencies by controlling the parties' communications of their respective levels of interest. In one example embodiment of the present invention, a system receives from the parties communications that include identifications of the counterparties, a specific issue between the parties, the parties' levels of interest in the issue, and potentially other associated comments. The system then compares the levels of interest and determines what messages to communicate to each party.

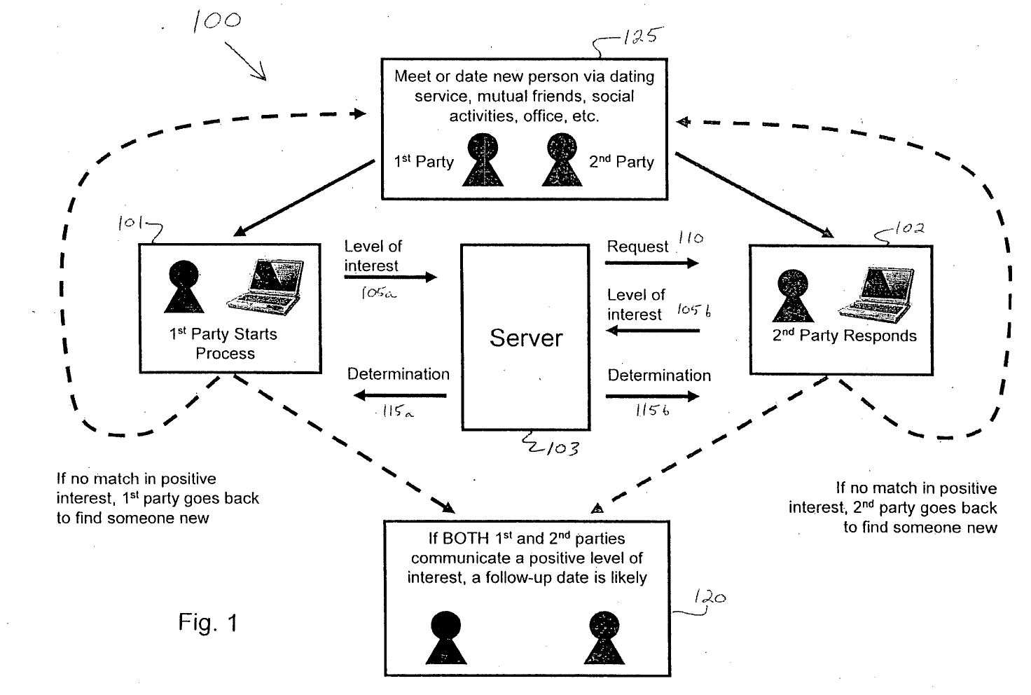

FIG. 1 is a flow diagram 100 illustrating controlling of communications in a romantic environment, according to an embodiment of the present invention. In this example romantic scenario, a first party 101 and a second party 102 meet or go on a date. After meeting, or going on the date, if the first party 101 wishes to determine whether there is a mutual level of interest in a romantic issue between the parties 101, 102, the first party 101 submits to a server 103 the identification of the second party 102 and his or her level of interest 105a in the romantic issue relating to the second party 102. The server 103 then notifies the second party 102 that the first party 101 has submitted a communication to the server 103 regarding the romantic issue and requests 110 that the second party 102 submit a communication to the server including the second party's level of interest 105b in the romantic relationship with the first party 101.

After the second party 102 submits his or her level of interest 105b to the server 103, the server 103 compares the two levels of interest 105a, 105b to determine messages 115a, 115b to communicate to each party 101, 102. It should be noted that the second party's level of interest 105b may be assumed to be a negative level of interest if the second party 102 does not submit his or her level of interest 105b within a given timeframe. In the illustrated embodiment, if both the first and second levels of interest 105a, 105b are positive, then the server 103 sends each party 101, 102 a communication 115a, 115b that includes a notification that the other party also has a positive level of interest in the romantic issue. However, if the first level of interest 105a is positive and the second level of interest 105b is negative, the server 103 conceals the first level of interest 105a from the second party 102. In this event, the server 103 still communicates the second level of interest 105b, or a representation thereof, to the first party 101, but the second party 102 is not informed of the communication.

Similarly, if the first level of interest 105a is negative and the second level of interest 105b is positive, then the server 103 conceals the second level of interest 105b from the first party 101. As above, the server 103 still communicates the first level of interest 105a, or a representation thereof, to the second party 102, but the first party 101 is not informed of the communication. Finally, if both the first and the second parties 101, 102 submit levels of interest 105a, 105b that are negative, neither level of interest is communicated to the other party. Upon receiving the messages 115a, 115b from the server 103, each party 101, 102 then takes actions that are based on the content of the messages 115a, 115b (e.g., go on another date 120, or search for another party 125).

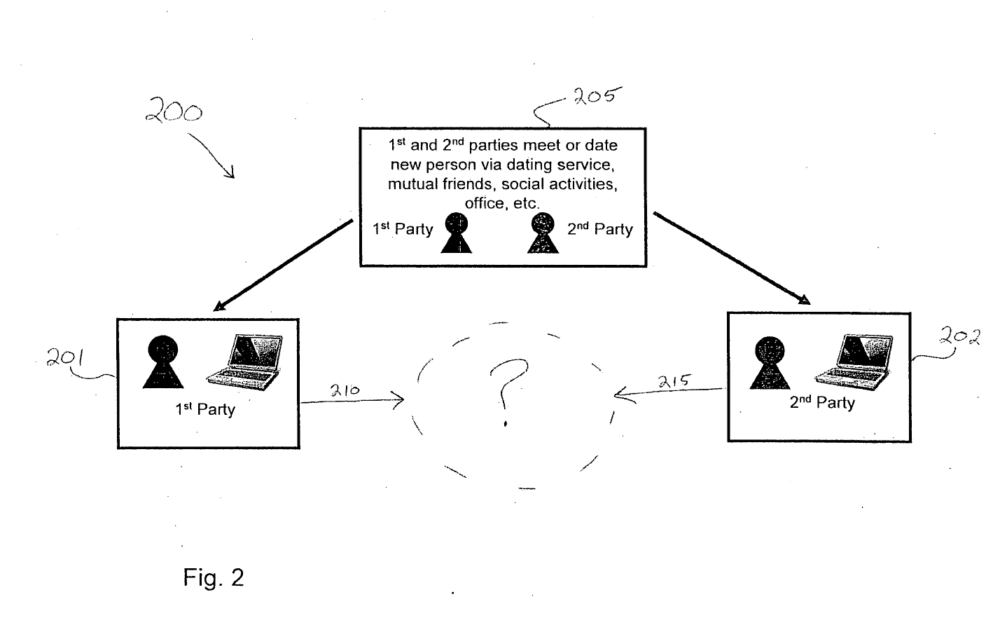

FIG. 2 is a flow diagram 200 illustrating events that take place prior to the controlling of communications, according to an embodiment of the present invention. According to the example embodiment of FIG. 2, a first party 201 and a second party 202 may meet each other face-to-face (e.g., through mutual friends, or at social or professional events) or online (e.g., through an online dating service) (205). The two parties 201, 202 typically exchange information, and may engage in a romantic outing, such as a date. Typically, after the parties meet, or go on a date, there is uncertainty as to whether the parties 201, 202 have a romantic interest in each other (210, 215).

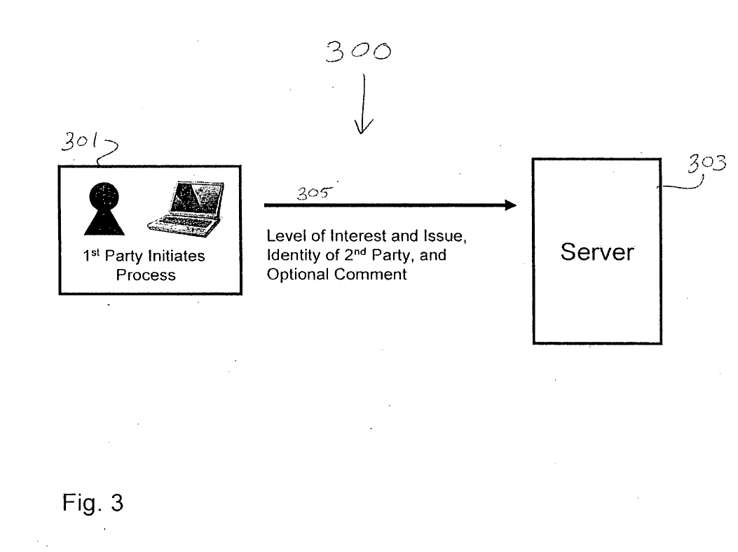

FIG. 3 is a flow diagram 300 illustrating a first party 301 initiating communications between parties, according to an embodiment of the present invention. According to the example embodiment of FIG. 3, the first party 301 may register, or may already be registered, with a communications controlling service 303. Once registered, the first party 301 sends a message 305 to the server 303 that includes the identity of a second party (not shown) and a first level of interest in an issue relating to the second party (e.g., romantic interest in the second party). The identity of the second party may take the form of a user name that is already registered with the communications controlling service 303, or may simply be an email address or other form of identification. The first party 301 may also include in the message 305 a comment regarding his or her level of interest in the issue. This comment may, for example, specify a suggested next step in a romantic relationship if the first party 301 has a positive level of interest in the issue, or may indicate a reason for having a negative level of interest.

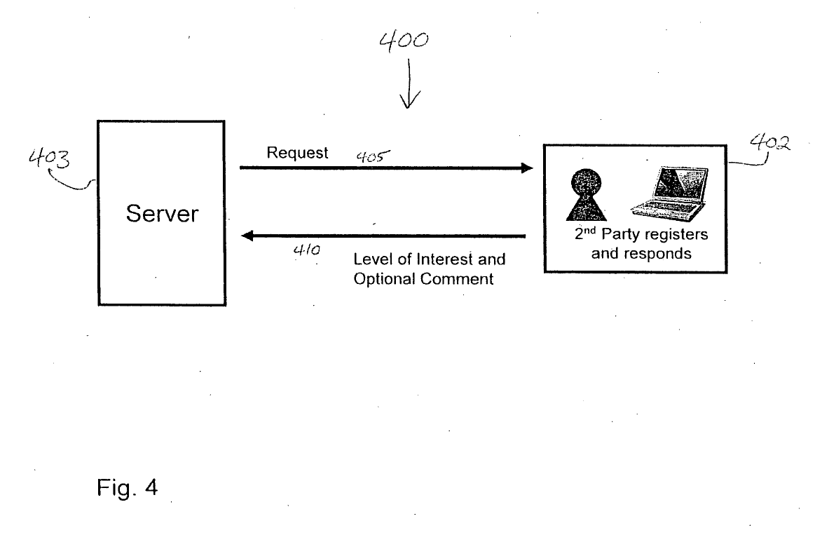

FIG. 4 is a flow diagram 400 illustrating requesting a communication from a second party 402, according to an embodiment of the present invention. According to the example embodiment of FIG. 4, once the server 403 receives a communication from the first party (not shown), the server 403 sends a message 405 to the specified second party 402 that includes the identity of the first party, the issue specified by the first party, and a notification that the first party has submitted his or her level of interest. Included in the message 405 from the server 403 may be a request for the second party 402 to send to the server 403 a second level of interest in the issue. It should be noted that the second party 402 may already be registered with the communications controlling service 403, or may be required to register with the service 403 before responding. The second party 402 may then send to the server 403 a communication 410 that includes a second level of interest in the issue and an optional comment regarding his or her level of interest in the issue. As above, the optional comment may propose a next step to take, or may include constructive criticism for the first party.

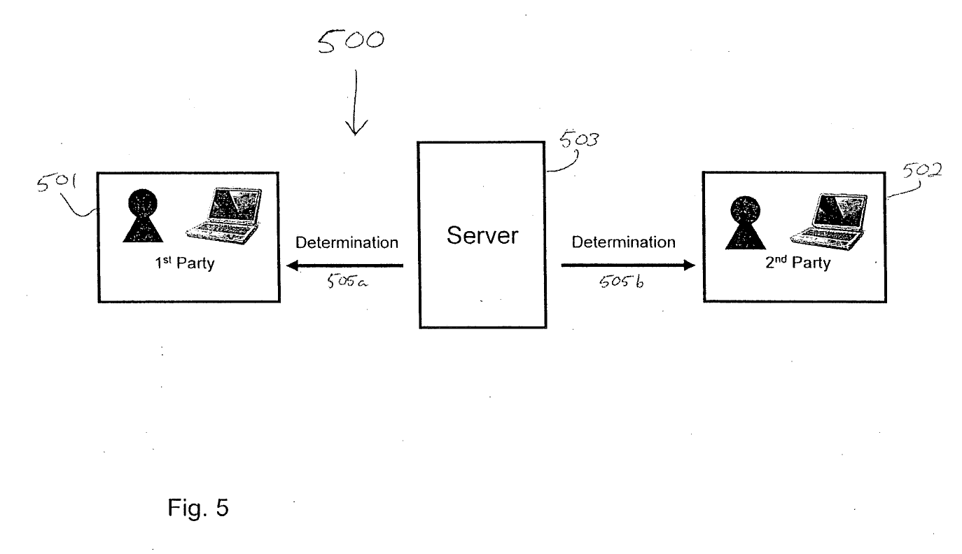

FIG. 5 is a flow diagram 500 illustrating determining and communicating messages 505a, 505b to parties 501, 502, according to an embodiment of the present invention. According to the example embodiment of FIG. 5, once the server 503 has received communications from both the first 501 and second 502 parties that include each of the parties respective level of interest, or has otherwise determined the parties' levels of interest, the server 503 then determines how to communicate a comparison of the levels of interest to the parties 501, 502. In one embodiment, representations of the levels of interest are sent to the parties 501, 502, instead of the actual levels of interest. In another embodiment, the actual levels of interest are sent to the parties 501, 502 unmodified by the server 503.

In the example embodiment, if both levels of interest are positive, the server 503 determines that messages 505a, 505b should be sent to both parties 501, 502, indicating that both of the levels of interest are positive. If, however, the first level of interest is positive and the second level of interest is negative, the server 505 determines that the second level of interest should be communicated to the first party 501 and that the first level of interest should be concealed from the second party 502. Likewise, if the second level of interest is positive and the first level of interest is negative, the server 503 determines that the first level of interest should be communicated to the second party 502 and that the second level of interest should be concealed from the first party 501. If both levels of interest are negative, the server 503 determines that neither of the levels of interest should be communicated to the parties 501, 502. The server 503 then prepares messages 505a, 505b for each of the parties 501, 502 based on the above determinations, and communicates each message 505a, 505b to the respective party 501, 502. It should be noted that the server 503 determines whether to include in the messages 505a, 505b any optional comments provided by the parties 501, 502 in their original communications to the server 503.

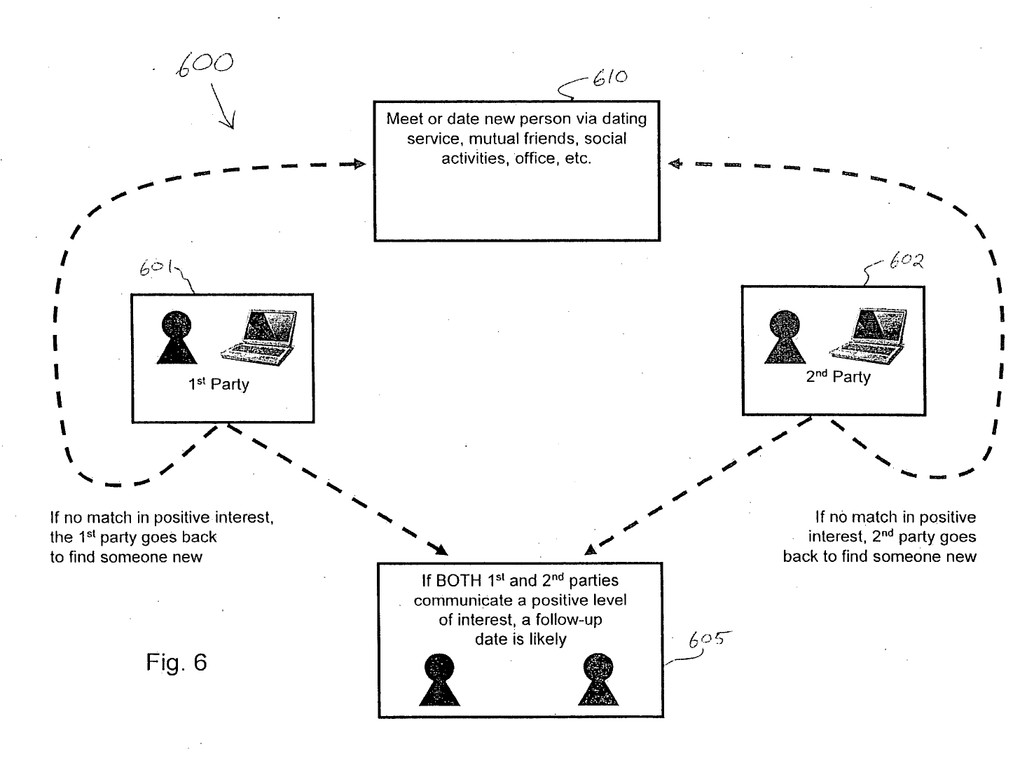

FIG. 6 is a flow diagram 600 illustrating parties 601, 602 receiving and processing messages and taking further action based on the messages, according to an embodiment of the present invention. According to the example embodiment of FIG. 6, upon receiving the messages communicated by the server (not shown), the parties 601, 602 process the messages and take further action based on the content of the messages. In one embodiment, for example, if both levels of interest are positive and the messages from the server indicate to the parties 601, 602 that there is match in positive levels of interest, the parties 601, 602 may contact each other to pursue a romantic relationship (605). If at least one of the parties 601, 602 included a comment in his or her communication to the server, the comment may be included in the messages from the server, and relied upon by the parties 601, 602 in taking their further action.

On the other hand, if the messages from the server indicate that there is not a match in positive levels of interest, then the parties 601, 602 will not likely attempt to contact each other again, but will instead pursue other potential romantic interests (610). If in a situation where one of the parties indicated a positive level of interest, and the counterparty indicated a negative level of interest with an optional comment providing constructive criticism, the party with the positive level of interest may be provided with the comment, and may consider its contents when pursuing other possible future romantic interests.

In other embodiments, a match in positive levels of interest may commit the parties 601, 602 to a predetermined action. For example, parties 601, 602 of a business negotiation may wish to agree on a certain document to be released to the public (e.g., through the press). In this example, the parties 601, 602 may specify that if there is a mutual positive level of interest, the document is automatically released.

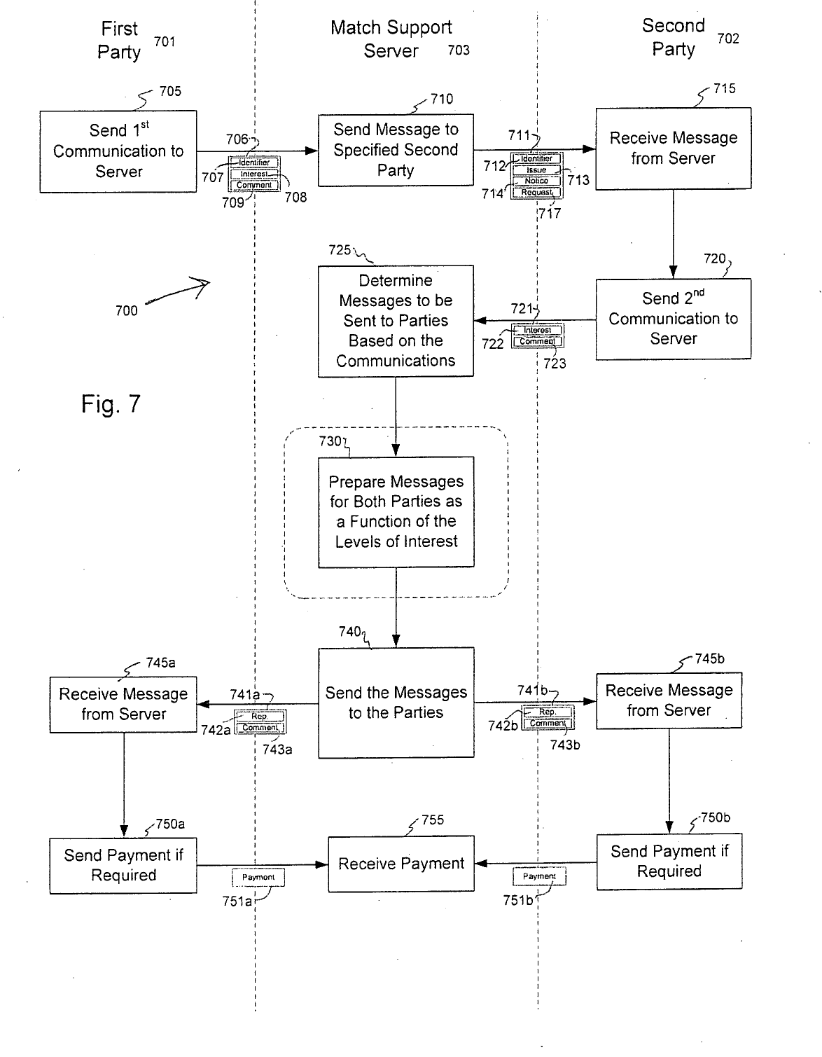

FIG. 7 is a detailed flow diagram 700 illustrating controlling of communications between two parties 701, 702, according to an embodiment of the present invention. If a first party 701 wishes to determine whether his or her interest in an issue relating to a second party 702 is mutual, he or she may send a communication 706 to a server 703 that controls communications between the parties 701, 702 (705). The issue may relate to many types of interests between the parties 701, 702, including, for example, a romantic or business interest. Generally, the parties 701, 702 are known to each other prior to sending any communications.

According to the example embodiment of FIG. 7, a first communication 706 sent by the first party 701 includes an identifier of the second party 707, an identification of an issue relating to the second party, the first party's level of interest 708 in the issue, and an optional comment 709 regarding the level of interest 708 or the issue in general.

The identifier of the second party 707 may take any form, including an email address, or account user name, depending on the specific configuration of the system for controlling the communications.

The level of interest 708 in the issue may take many forms. For example, the party 701 may be limited to a choice between two values as the level of interest 708, for example, a positive value (e.g., “yes”) and a negative value (e.g., “no”). Alternatively, the party 701 may be given a wide range of values from which he or she may chose, such as a score ranging from 0 to 100.

The optional comment 709 may relate to the first party's reason for having a particular level of interest 708, or may relate to the issue in general. For example, if the issue is that of a romantic interest, the comment 709 may indicate a reason why the party 701 has a particular level of interest 708, or may indicate a proposed next step to take in the romantic relationship.

Upon receiving the first communication 706 from the first party 701, the server 703 sends a message 711 to the second party 702 indicated by the identifier 707 received from the first party 701 (710). The message 711 includes an identifier of the first party 712, the issue 713 specified by the first party 701, and a notice 714 to the second party 702 that the first communication 706 has been received from the first party 701. It should be noted that the message 711 from the server 703 to the second party 702 does not include the first party's level of interest 708 or the optional comment 709, as the second party 702 must not be immediately informed of the first party's 701 thoughts on the issue 713.

The server 703 sends a request 717 to the second party 702 to submit a communication that includes the second's party's level of interest in the issue. In one embodiment, the second party 702 then sends a second communication 721 that includes his or her level of interest 722 in the issue and an optional comment 723 relating to his or her level of interest 722 in the issue (720). Like the first level of interest 708, the second level of interest 722 may take many forms, including a binary value (e.g., positive or negative), or a particular value within a range of values (e.g., 70 out of 100). Like the optional comment from the first party 709, the second party's optional comment 723 may relate to a reason for having a particular level of interest 722, or may relate to the issue in general. In another embodiment, the request 717 sent to the second party 702 may include a specified timeframe for submitting the second communication 721. In such an embodiment, the second communication 721 may be assumed to include a negative (or other default) level of interest 722 if the second party 702 does not submit the second communication 721 within the specified timeframe. Additionally, the optional comment 723 may indicate that the second party 702 failed to respond.

It should be noted that the server 703 may make the request 717 that the second user 702 send the second communication 721 at the same time the server 703 informs the second party 702 of the communication 706 received from the first party 701 (710).

The server 703 then determines messages 741a, 741b to send to the parties 701, 702 based on the communications 706, 721 received from the parties 701, 702 (725). For instance, if the first party 701 indicated a positive level of interest (e.g., “yes”) in his or her communication 706 and the second party 702 indicated a negative level of interest (e.g., “no”) in his or her communication 721, then the first party 701 would want to know of the second party's negative level of interest 722 without the second party 702 knowing of his or her positive level of interest 708. Thus, if the issue is that of a romantic interest, the method of controlling communications allows the first party 701 to determine if there are mutual levels of interest 708, 722 in the issue 713 without suffering the embarrassment of rejection.

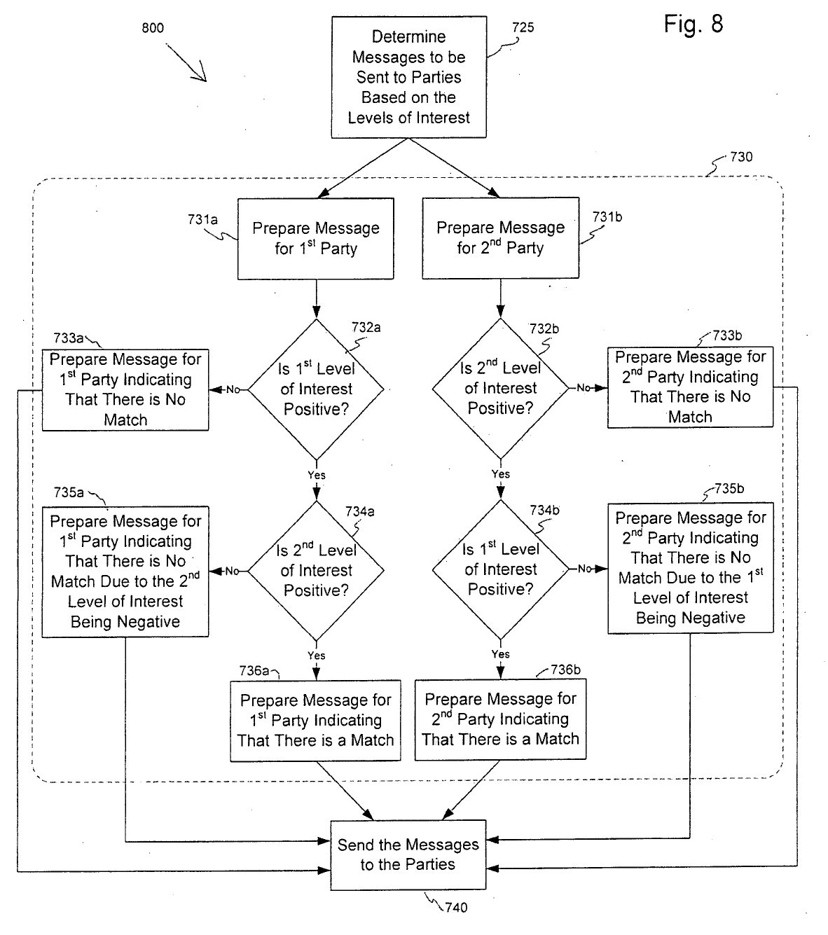

FIG. 8 is a detailed flow diagram 800 illustrating logic used in the controlling of communications in FIG. 7. The server 703 makes the determination as a function of the levels of interest 708, 722 (730). In the example embodiment, the logic used to make the determination includes preparing a first message 741a to be sent to the first party 701 (731a), and a second message 741b to be sent to the second party 702 (731b).

In preparing the first message 741a, the server 703 first considers the first party's level of interest 708 (732a). If the first level of interest 708 is negative, then the server 703 does not allow the first party 701 to know of the second party's level of interest 722, thus, in choosing a negative level of interest, the first party 701 forfeits the right to know of the second party's level of interest 722. This helps prevent potential embarrassment on the part of the second party 702. If the first party 701 submits a negative level of interest 708, a message 741a is prepared for the first party 701 indicating that there is no mutual desire by the parties 701, 702 to pursue the issue at hand (733a). It should be noted that neither the level of interest 722 nor the optional comment 723 of the second party 702 is shared with the first party 701.

If, however, the level of interest 708 of the first party 701 is positive, then the server 703 must consider the second party's level of interest 722 as well (734a). If the second level of interest 722 is positive, then a message 741a is prepared for the first party 701 indicating that there is a mutual level of positive interest (736a). The message 741a includes a representation of the second parties' level of interest 742a, which may be, in one embodiment, the actual level of interest 722 submitted by the second party 702. Included in this message may be any comment 723 provided by the second party 702. If the issue relates to that of a romantic interest, for example, the comment 723 may provide a suggestion as to what the parties 701, 702 should do next (e.g., go on another date).

On the other hand, if the second level of interest 722 is negative, then a message 741a is prepared for the first party 701 indicating that there is not a positive interest by the second party 702 for the issue (735a). It should be noted that in this situation, a representation of the negative level of interest 742a of the second party 702 is shared with the first party 701 so that the first party 701 may focus his or her efforts elsewhere. In one embodiment, the representation of the level of interest 742a is the actual level of interest 722. Additionally, if the second user 702 provided a comment 723 with his or her level of interest 722, then that comment 723 is shared with the first party 701 as well. If the issue relates to that of a business interest, for example, the comment 723 may provide the first party 701 with constructive criticism for use in future business dealings.

Similarly, the server 703 prepares a second message 741b to send to the second party 702 (731b). The server 703 first considers the second party's level of interest 722 (732b). If the second level of interest 722 is negative, then the server 703 does not allow the second party 702 to know of the first party's level of interest 708. A message 741b is prepared for the second party 702 indicating that there is no mutual desire by the parties 701, 702 to pursue the issue at hand (733b). As noted above, neither the level of interest 708 nor the optional comment 709 of the first party 701 is shared with the second party 702.

If, however, the level of interest 722 of the second party 702 is positive, then the server 703 must consider the first party's level of interest 708 as well (734b). If the first level of interest 708 is positive, then a message 741b is prepared for the second party 702 indicating that there is a mutual level of positive interest (736b). The message 741b includes a representation of the first party's level of interest 742b, which may be, in one embodiment, the actual level of interest 708 submitted by the first party 701. Included in this message 741b is any comment 709 provided by the first party 701.

On the other hand, if the first level of interest 708 is negative, then a message 741b is prepared for the second party 702 indicating that there is not a positive interest by the first party 701 for the issue (735b). As noted above, a representation of the negative level of interest of the first party 742b is shared with the second party 702 so that the second party 702 may focus his or her efforts elsewhere. In one embodiment, the representation of the level of interest 742b is the actual level of interest 708. Additionally, if the first party 701 provided a comment 709 with his or her level of interest 708, then that comment 709 is shared with the second party 702 as well.

Returning to FIG. 7, the prepared messages 741a, 741b are sent to the parties 701, 702 (740). Upon receiving the messages 741a, 741b, the parties 701, 702 then either focus their efforts on the issue 713 or on other interests based on the messages 741a, 741b prepared by the server 703 (745). If payment by the parties is required, such as a fee in the case of mutual positive levels of interest in the example embodiment, then the parties 701, 702 send their respective payments 751a, 751b to the server 703 (750). Upon receiving the payments 751a, 751b at the server 703, the process is complete (755). In other embodiments, payment from the parties 701, 702 may be required earlier in the process, such as when sending the communications 706, 721 to the server 703 (705, 720). In such a situation, the payments may be refunded in the case there is no mutual positive level of interest. In other embodiments, the payment by the parties may be sent to a financial institution (not shown) in lieu of the server 703.

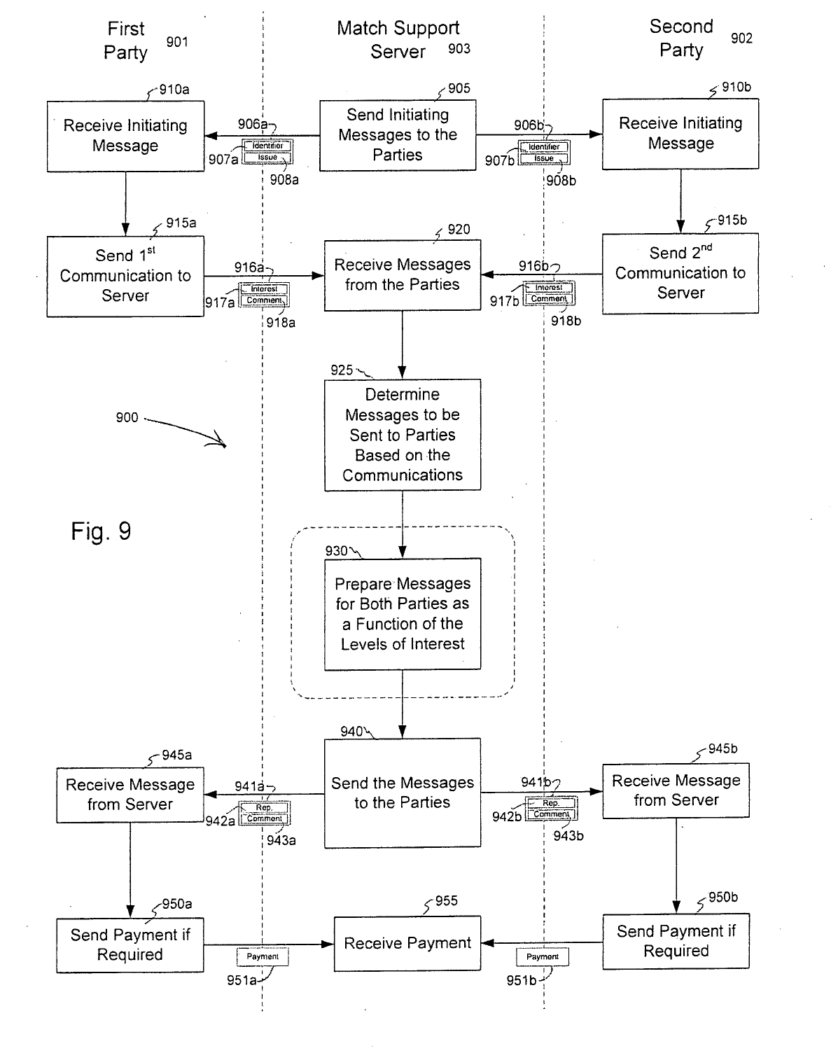

FIG. 9 is a detailed flow diagram 900 illustrating initiating and controlling of communications between two parties 901, 902. According to the example embodiment of FIG. 9, the server 903 may initiate communications between the parties 901, 902. In such an embodiment, the server 903 may store information relating to the parties 901, 902, such as the issue 908 between the parties and an event that triggers initiation of the communications. For example, if the issue 908 is that of a romantic interest, the sever 903 may store information about a date involving the parties 901, 902. When a certain amount of time passes after the date takes place, the server 903 may send messages 906a, 906b to the parties 901, 902 for the purpose of initiating communications (905). Each message 906a, 906b includes an identification of the other party 907a, 907b and the issue 908 about which the parties 901, 902 submit communications.

Upon receiving the messages 906a, 906b from the server 903 (910), each party 901, 902 may then submit a communication 916a, 916b to the server 903 including the party's level of interest 917a, 917b in the issue 908, and an optional comment 918a, 918b (915). As in the case where the first party 701 initiates communications (FIG. 7), a particular party's level of interest 917 may be assumed to be a negative level of interest if the party does not submit his or her communication 916 to the server 903 within a specified timeframe. Upon receiving the communications 916a, 916b (920), or otherwise determining the parties' levels of interests 917a, 917b, the server 903 determines messages 941a, 941b to send to the parties 901, 902, and sends the messages 941a, 941b to the parties 901, 902 in a similar manner as described in the context of FIGS. 7 and 8 (925-955).

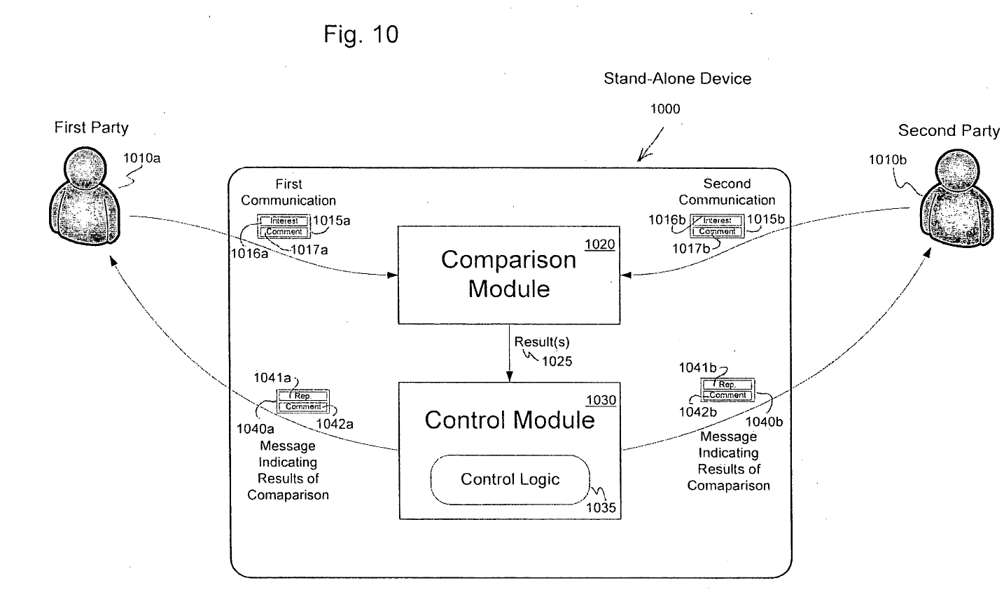

FIG. 10 is a block diagram illustrating controlling communications between two parties 1010a, 1010b. According to the example embodiment of FIG. 10, the present invention may take the form of a stand-alone device 1000 that controls communications between the parties 1010a, 1010b. In the example embodiment, the parties 1010a, 1010b may be positioned on either side of the device 1000, and may, or may not, be able to see each other. Each party 1010a, 1010b submits a communication 1015a, 1015b to the device 1000 that includes the party's level of interest in an issue 1016a, 1016b and an optional comment 1017a, 1017b. At least one of the communications 1015a, 1015b may include an identification of the issue, or the issue may be known to the parties 1010a, 1010b before submitting the communications 1015a, 1015b. A comparison module 1020 then examines the communications 1015a, 1015b, and a control module 1030 prepares messages 1040a, 1040b to send to the parties 1010a, 1010b based on result(s) 1025. The control module 1030 determines the messages 1040a, 1040b to send to the parties 010a, 1010b based on control logic 1035 and the parties' levels of interest 1016a, 1016b. The control module 1030 then sends the prepared messages 1040a, 1040b to the parties 1010a, 1010b, which include representations of the parties' level of interests 1041a, 1041b and any optional comments 1042a, 1042b submitted by the parties 1010a, 1010b.

In an example embodiment, a match in positive levels of interest 1041a, 1041b may commit the parties 1010a, 1010b to a predetermined action. For example, parties of a business negotiation may wish to agree on a joint-statement or memorandum of understanding. In such a situation, the parties 1010a, 1010b may be reluctant to be the first to express a positive level of interest as it may put that party in a weaker bargaining position. In this example, the parties 1010a, 1010b may specify that once mutual positive levels of interest 1041a, 1041b for the joint-statement or memorandum exist, then the parties are automatically bound to the document. Thus, in addition to sending the messages 1040a, 1040b to the parties 1010a, 1010b, the parties are committed to an predefined action or to additional communications. It should be understood that committing the parties to a predetermined action may be applied not only to the device 1000 of FIG. 10, but to all embodiments of the present invention.

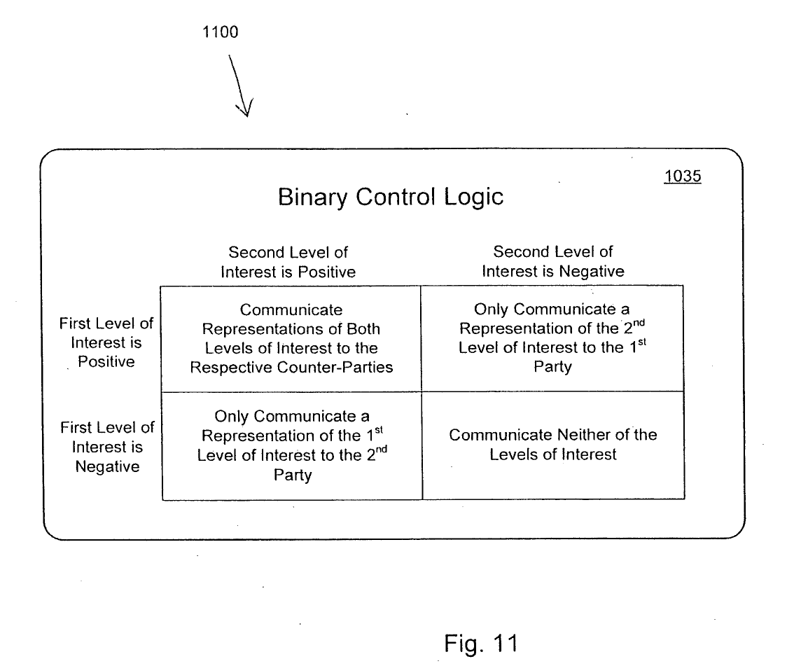

FIG. 11 is a block diagram 1100 illustrating binary logic used in the controlling of communications in FIG. 10. The device 1000 of FIG. 10 determines what messages 1040a, 1040b to send to the parties 1010a, 1010b as a function of the parties' levels of interest 1016a, 1016b.

In one example embodiment, the logic 1035 used to make the determination may be based on binary levels of interest. Such binary levels of interest may include positive and negative levels of interest (e.g., “yes” and “no” values). In the case of binary values, if both levels of interest 1016a, 1016b are positive, then messages 1040a, 1040b are communicated to both parties 1010a, 1010b indicating that a mutual positive level of interest exists. These messages 1040a, 1040b include a representation of the other party's level of interest 1041a, 1041b, which may be the actual level of interest 1016a, 1016b, and may include any comment 1017a, 1017b that the other party submitted.

If the first party's level of interest 1016a is positive and the second party's level of interest 1016b is negative, then a representation of the second level of interest 1041a is communicated to the first party 1010a along with any comment 1042a submitted by the second party 1010b, while the first level of interest 1016a, and any comment submitted by the first party 1017a, is concealed from the second party 1016b.

Likewise, if the second party's level of interest 1016b is positive and the first party's level of interest 1016a is negative, then a representation of the first level of interest 1041b is communicated to the second party 1010b along with any comment 1042b submitted by the first party 1010a, while the second level of interest 1016b, and any comment 1017b submitted by the second party 1010b, is concealed from the first party 1010a.

In the case that both levels of interest 1016a, 1016b are negative, neither of the levels of interest 1016a, 1016b, nor representations 1041a, 1041b thereof, are communicated to the parties 1010a, 1010b.

Levels of interest may not only be binary valued, but may be ternary valued, or may even be a value within a range of values (e.g., a score in the range from 0 to 100, or percentile score). For example, ternary valued levels of interest may be submitted by the parties (e.g., “yes”, “no”, or “maybe”).

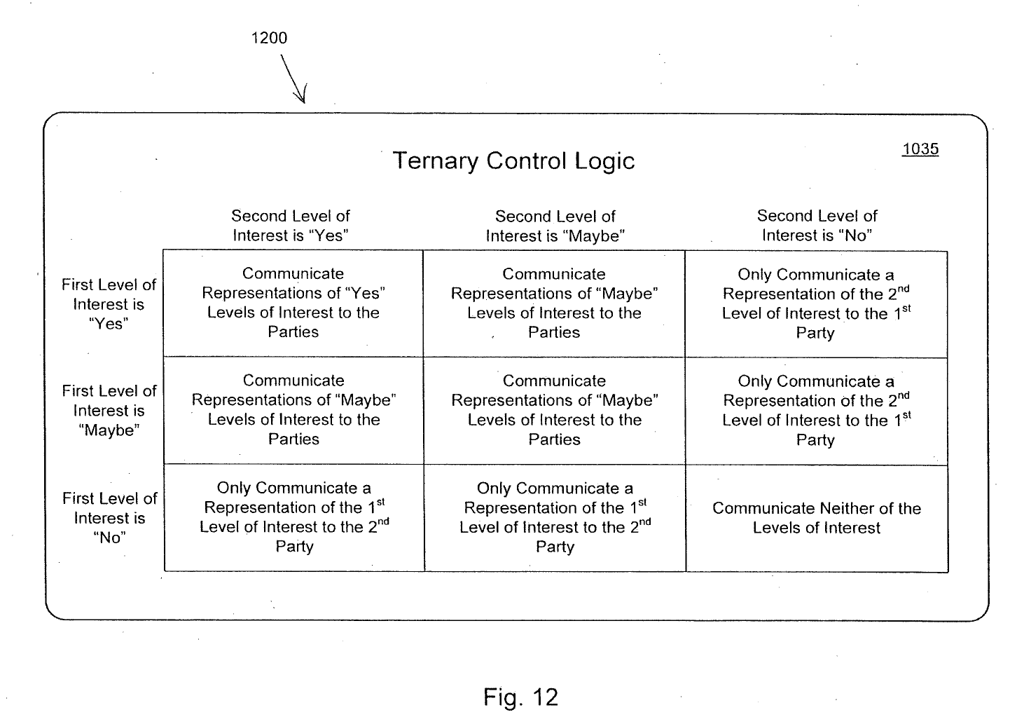

FIG. 12 is a block diagram 1200 illustrating ternary logic used in the controlling of communications in FIG. 10. In embodiments with such ternary valued levels of interest, if both parties 1010a, 1010b submit a non-negative level of interest (i.e., “yes” or “maybe”), the device 1000 communicates the lower-valued level of interest to both parties 1010a, 1010b. For instance, if the first party 1010a submits a “yes” and the second party 1010b submits a “maybe”, the device 1000 communicates messages 1040a, 1040b to both parties 1010a, 1010b indicating that there is a mutual “maybe” level of interest.

If either of the parties 1010a, 1010b submit a negative level of interest (e.g., “no”), the device 1000 communicates messages 1040a, 1040b in the same manner as with binary valued levels of interest (i.e., a party submitting a negative level of interest forfeits the right to know of the other party's level of interest.)

In embodiments with multi-valued levels of interest (e.g., a score ranging from 0 to 100), the device 1000 may communicate either the lowest-valued level of interest of the submitted levels of interest, or may communicate messages 1040a, 1040b to the parties 1010a, 1010b based on threshold values. For example, in a situation where scores ranging from 0 to 100 are used, a threshold may be defined such that scores below “50” are considered to be negative levels of interest, and scores of “50” and above are considered to be positive. Further, this threshold scheme may include using multiple thresholds to indicate multiple tiers of interest. Alternatively, a threshold may be defined based on the difference between the levels of interest 1016a, 1016b such that if the difference between the levels of interest 1016a, 1016b falls below the threshold, the device 1000 communicates the levels of interest 1016a, 1016b to the parties 1010a, 1010b, but if the difference is greater than the threshold, the higher level of interest is concealed from the party with the lower level of interest.

For example, if the first party 1010a submits a level of interest 1016a of “70”, and the second party 1010b submits a level of interest 1016b of “80”, the difference between the levels of interest is “10”. If, in this example, a threshold is set at a difference of “15”, then both levels of interest 1016a, 1016b, or representations 1041a, 1041b thereof, are communicated to the parties 1010a, 1010b. If, however, the threshold was set at a difference of “5”, then the device 1000 communicates the lower level of interest 1016a of “70”, or a representation 1041b thereof, to the second party 1010b, while concealing the higher level of interest 1016b from the first party 1010a. It should be understood that logic involving binary, ternary, or multi-valued levels of interest may be applied not only to the device 1000 of FIG. 10, but to all embodiments of the present invention.

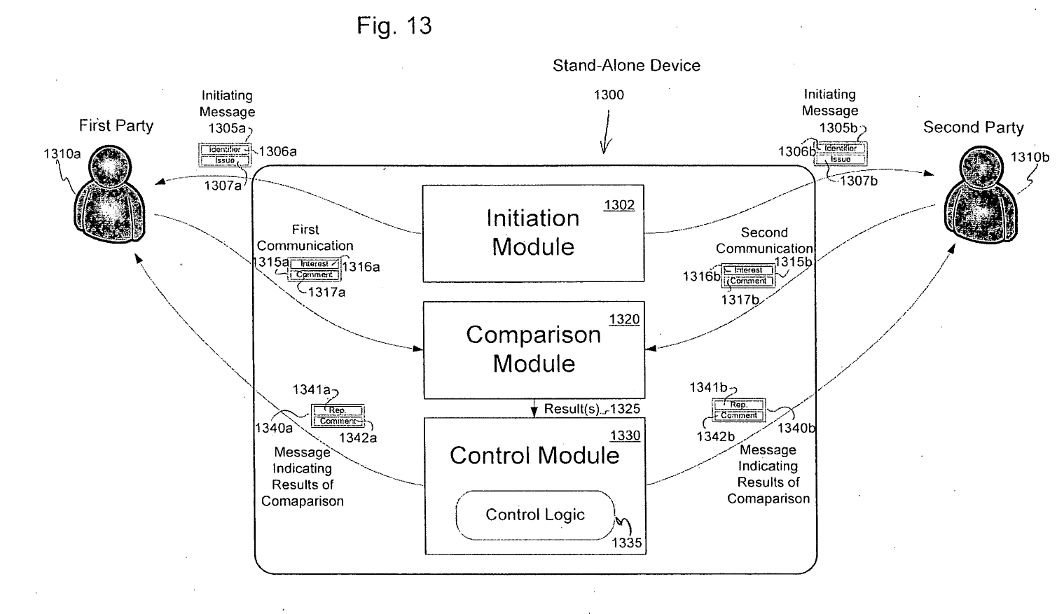

FIG. 13 is a block diagram illustrating initiating and controlling of communications between two parties 1310a, 1310b. According to the example embodiment of FIG. 13, a device 1300 may initiate communications between the parties 1310a, 1310b. In such an embodiment, the device 1300 includes an initiation module 1302 that sends messages 1305a, 1305b to the parties 1310a, 1310b for the purpose of initiating communications between the parties 1310a, 1310b. The messages 1305a, 1305b sent to the parties include an identification of the other party 1306a, 1306b, and the issue 1307a, 1307b about which the parties 1310a, 1310b submit communications.

Each party 1310a, 1310b then submits a communication 1315a, 1315b to the device 1300 including the party's level of interest 1316a, 1316b in the issue, and an optional comment 1317a, 1317b. Upon receiving the communications 1315a, 1315b, the device 1300 determines messages 1340a, 1340b to send to the parties 1310a, 1310b, and sends the messages 1340a, 1340b to the parties 1310a, 1310b in a similar manner as described in the context of FIGS. 10-12 (1320-1342).

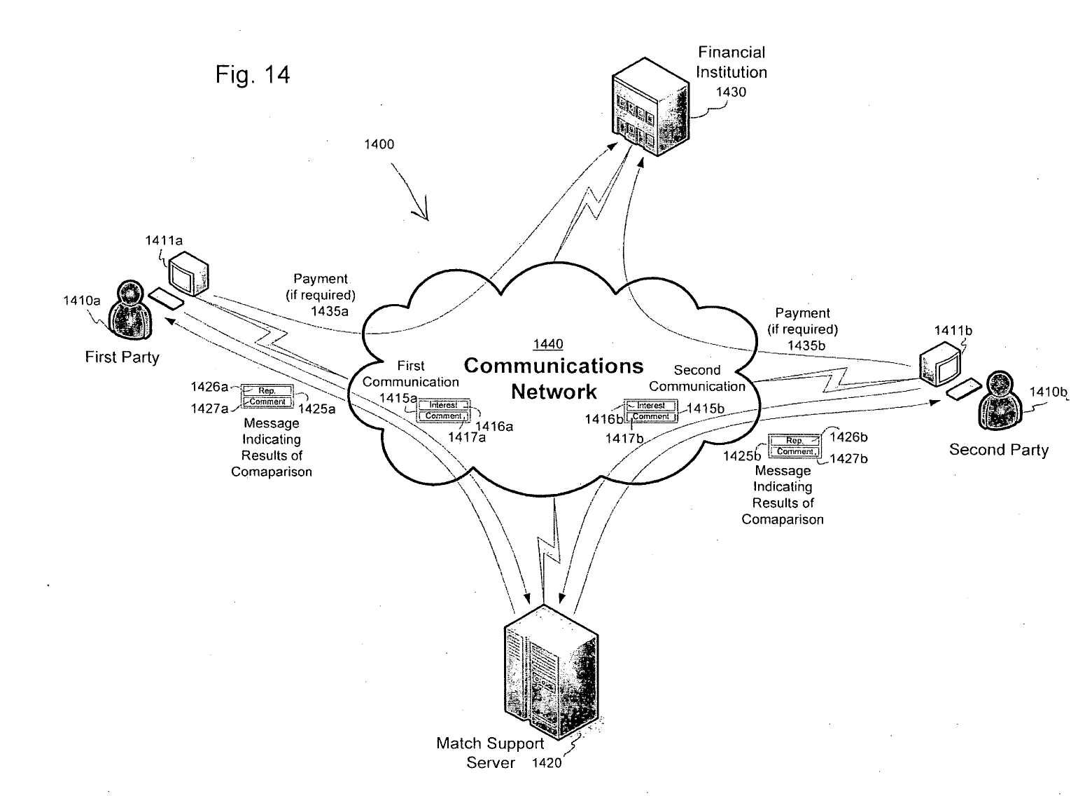

FIG. 14 is a network diagram 1400 illustrating controlling of communications between two parties 1410a, 1410b. According to the example embodiment of FIG. 14, the present invention may take the form of a server 1420 that controls communications between the parties 1410a, 1410b in a communications network 1440, such as the Internet. In the example embodiment, the first party 1410a uses a first interface 1411a to submit a communication 1415a that includes a level of interest 1416a and an optional comment 1417a. Likewise, the second party 1410b uses a second interface 1411b to submit a communication 1415b that includes a level of interest 1416b and an optional comment 1417b. The interfaces 1411a, 1411b may be mobile devices or personal computers connected to a network, or may be terminals or kiosks positioned in public areas, such as shopping malls.

The communications 1415a, 1415b are then compared by the server 1420, and messages 1425a 1425b to be sent to the parties 1410a, 1410b are prepared as a function of the parties' levels of interest 1416a, 1416b. The messages 1425a, 1425b include representations of the parties' level of interests 1426a, 1426b and any optional comments 1427a, 1427b submitted by the parties 1410a, 1410b. The server 1420 then sends the prepared messages 1425a, 1425b to the parties 1410a, 1410b via the communication network 1440. If payment by the parties is required, such as a fee in the case of mutual positive levels of interest in the example embodiment, then the parties 1410a, 1410b may send their respective payments 1435a, 1435b to the required destination, such as the server 1420, or a financial institution 1430, such as a bank. In other embodiments, payment from the parties may be required earlier in the process, such as when sending the communications 1415a, 1415b to the server 1420. In such a situation, the payments may be refunded in the case there is not a mutual positive level of interest.

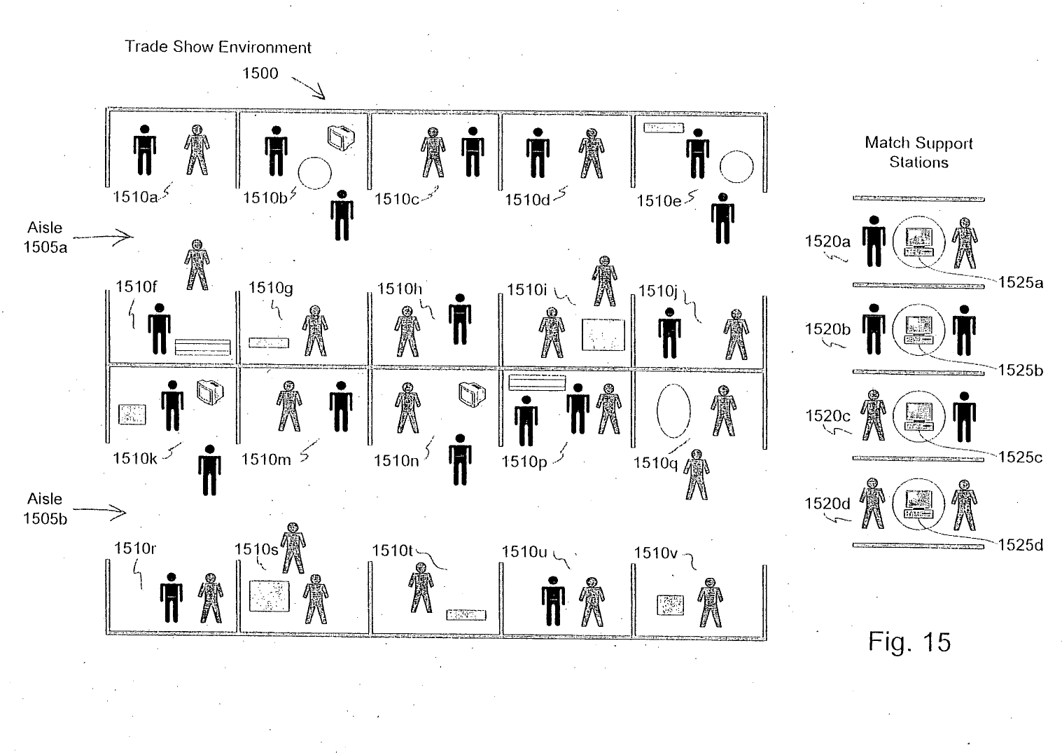

FIG. 15 is a schematic diagram of a trade show type environment 1500 in which an embodiment of the present invention is deployed. In a typical tradeshow environment, sellers set up displays in booths 1510a-v that are arranged in a number of aisles 1505a, 1505b, with the goal of attracting prospective buyers to their displays. When the sellers and buyers meet, there may be some exchange of information, such as business cards, phone numbers, email, or the like. If either party is interested, they must communicate with the other party at a future point in time to determine if the other party is equally interested. As in the romantic arena, there exists a feeling of rejection when one business party indicates that they are not interested, or at least not as interested as the other party.

According to the example embodiment of FIG. 15, stand-alone devices 1525a-d may be positioned 1520a-d near the aisles 1505a, 1505b of the trade show 1500. Sellers and buyers may use the devices 1525a-d after meeting with one another to determine if there is a mutual positive level of interest worth pursuing. The devices 1525a-d may or may not be managed by personnel trained in the operation of the devices. In another embodiment, the parties may agree to use an online service to submit their levels of interest after meeting at the trade show 1500. Upon receiving the parties' levels of interest and optional comments, the online service sends messages to the parties indicating representations of the levels of interest, and any comments submitted, as a function of the levels of interest, much like as described in the forgoing embodiments.

While this invention has been particularly shown and described with references to example embodiments thereof, it will be understood by those skilled in the art that various changes in form and details may be made therein without departing from the scope of the invention encompassed by the appended claims. For example, while the above embodiments relate to either romantic or business relationships, the present invention may be used for other purposes, such as controlling communications between parties of a diplomatic discussion.

Additionally, it should be understood that the flow diagrams of FIGS. 1-9 are examples that can include more or fewer components, be partitioned into subunits, or be implemented in different combinations. Moreover, the flow diagrams may be implemented in hardware, firmware, or software. If implemented in software, the software may be written in any software language suitable for use in a network as illustrated in FIGS. 14. The software may be embodied on any form of computer readable medium, such as RAM, ROM, or magnetic or optical disk, and loaded and executed by generic or custom processor(s).

It should be further understood that a given party may include a single person, multiple people, or an automated process, and that communicating representations of the levels of interest between the parties as a function of the levels of interest may include communicating the representations, communicating the levels of interest, withholding communications, or any combination thereof.

What is claimed is:

1. A method of controlling communications between parties known to each other, the method comprising:
receiving from a first party a first communication including a first level of interest in an issue relating to a second party, the first and the second parties being identified to each other; and
requesting from the second party a second communication including a second level of interest in the issue; and
communicating a first representation of the first level of interest to the second party and a second representation of the second level of interest to the first party as a function of the first and second levels of interest.

2. The method of claim 1 wherein the first communication includes an identification of the second party; and
wherein requesting the second communication from the second party includes informing the second party of the identity of the first party, the issue, and receipt of the first communication from the first party.

3. The method of claim 1 further comprising initiating communications between the first and second parties responsive to prompting by a third party.

4. The method of claim 3 wherein the third party is an automated server.

5. The method of claim 1 wherein the representations of the levels of interest are the actual levels of interest.

6. The method of claim 1 wherein each level of interest has one of multiple values, and communicating the representations includes communicating to the parties the lowest-valued level of interest of the first and second levels of interest.

7. The method of claim 1 wherein the second communication is assumed to include a negative level of interest in the issue if the second communication is not received from the second party within a given timeframe.

8. The method of claim 1 wherein communicating the representations as a function of the levels of interest includes communicating both representations if both levels of interest are positive.

9. The method of claim 8 wherein communicating the representations includes triggering additional communications or actions by the parties.

10. The method of claim 1 wherein communicating the representations as a function of the levels of interest includes withholding communication of the first representation if the second level of interest is negative.

11. The method of claim 1 wherein communicating the representations as a function of the levels of interest includes withholding communication of the second representation if the first level of interest is negative.

12. The method of claim 1 wherein communicating the representations as a function of the levels of interest includes communicating the first representation to the second party if the first level of interest is negative and the second level of interest is positive.

13. The method of claim 1 wherein communicating the representations as a function of the levels of interest includes communicating the second representation to the first party if the second level of interest is negative and the first level of interest is positive.

14. The method of claim 1 wherein receiving the first communication from the first party includes receiving a comment, and wherein communicating the representations as a function of the levels of interest includes communicating the comment to the second party.

15. The method of claim 1 wherein requesting the second communication from the second party includes requesting a comment, and wherein communicating the representations as a function of the levels of interest includes communicating the comment to the first party.

16. The method of claim 1 wherein communications are performed in a mobile network.

17. The method of claim 1 wherein communications are performed through at least one user interface of a computer network.

18. The method of claim 1 wherein communications are performed through electronic messaging.

19. The method of claim 1 further including adding the method to a system normally supporting other forms of communications services for the first and second parties.

20. The method of claim 1 further including collecting payment from at least one of the parties if both the first and second levels of interest are positive.

21. The method of claim 1 wherein the levels of interest are interpersonal levels of interest.

22. The method of claim 21 wherein the levels of interest relate to a romantic relationship.

23. The method of claim 1 wherein the levels of interest are business levels of interest.

24. The method of claim 1 wherein the levels of interest are diplomatic levels of interest.

25. A method of controlling communications between parties known to each other, the method comprising:
comparing first and second levels of interest in respective first and second communications received from respective first and second parties submitting the communications, the first and the second parties being identified to each other; and
(i) reporting representations of the levels of interest to the first and second parties if both the first and second levels of interest are positive, (ii) (a) concealing the second level of interest from the first party if the first level of interest is negative, and (b) concealing the first level of interest from the second party if the second level of interest is negative, or (iii) (a) reporting a representation of the first level of interest to the second party if the first level of interest is negative and the second level of interest is positive, and (b) reporting a representation of the second level of interest to the first party if the second level of interest is negative and the first level of interest is positive.

26. A system for controlling communications between parties known to each other, the system comprising;
a comparison module that compares first and second levels of interest in respective first and second communications received from respective first and second parties submitting the communications, the first and the second parties being identified to each other; and
a control module that communicates a first representation of the first level of interest to the second party and a second representation of the second level of interest to the first party as a function of the first and second levels of interest.

27. The system of claim 26 wherein the representations of the levels of interest are the actual levels of interest.

28. The system of claim 26 wherein the control module communicates both representations if both levels of interest are positive.

29. The system of claim 26 wherein the control module withholds communication of the first representation if the second level of interest is negative.

30. The system of claim 26 wherein the control module withholds communication of the second representation if the first level of interest is negative.

31. The system of claim 26 wherein the control module communicates the first representation to the second party if the first level of interest is negative and the second level of interest is positive.

32. The system of claim 26 wherein the control module communicates the second representation to the first party if the second level of interest is negative and the first level of interest is positive.

33. The system of claim 26 further including an initiation module that initiates communications between the first and second parties.

34. A network for controlling communications between parties known to each other, the network comprising:
a first user interface to submit a first communication by a first party, the first communication including a first level of interest in an issue relating to a second party, the first and the second parties being identified to each other; and
a second user interface to submit a second communication by the second party, the second communication including a second level of interest in the issue; and
a server to (i) compare the levels of interest, and (ii) communicate a first representation of the first level of interest to the second party and a second representation of the second level of interest to the first party as a function of the first and second levels of interest.

35. The network of claim 34 wherein the representations of the levels of interest are the actual levels of interest.

36. The network of claim 34 wherein the server communicates both representations if both levels of interest are positive.

37. The network of claim 34 wherein the server withholds communication of the first representation if the second level of interest is negative.

38. The network of claim 34 wherein the server withholds communication of the second representation if the first level of interest is negative.

39. The network of claim 34 wherein the server communicates the first representation to the second party if the first level of interest is negative and the second level of interest is positive.

40. The network of claim 34 wherein the server communicates the second representation to the first party if the second level of interest is negative and the first level of interest is positive.

41. The network of claim 34 wherein the server initiates communications between the first and second parties.

42. A computer readable medium having computer readable program codes embodied therein for controlling communications between parties known to each other, the computer readable medium program codes including instructions that, when executed by a processor, cause the processor to:
receive from a first party a first communication including a first level of interest in an issue relating to the second party, the first and the second parties being identified to each other; and
receive from the second party a second communication including a second level of interest in the issue; and
communicate a first representation of the first level of interest to the second party and a second representation of the second level of interest to the first party as a function of the first and second levels of interest.
